(19) United States
(12) Patent Application Publication
(10) Pub. No.: US 2007/0234126 A1
(43) Pub. Date: Oct. 4, 2007

(54) Accelerating the testing and validation of new firmware components

(76) Inventors: Ju Lu, Shanghai (CN); Carl Shi, Shanghai (CN); Michael A. Rothman, Puyallup, WA (US); Alex Gu, Shanghai (CN); Yuanyuan Xing, Shanghai (CN); Benjamin You, Shanghai (CN)

Correspondence Address: TROP PRUNER & HU, PC, 1616 S. VOSS ROAD, SUITE 750, HOUSTON, TX, 77057-2631, US

(21) Appl. No.: 11/390,659

(22) Filed: Mar. 28, 2006

(51) Int. Cl. G06F 11/00

(52) U.S. Cl. 714/38

(57) ABSTRACT

New firmware versions may be tested more efficiently and more quickly by making an analysis of how a change in the firmware affects components, protocols, and drivers. Based on a determination of the dependencies between the changed components, drivers, and protocols, a list of tests that need to be undertaken can be derived. This list of tests may be much less extensive than all the tests that would normally be run to validate a new version of the firmware. As a result, the test time may be reduced in some embodiments.

### BACKGROUND

This invention relates generally to firmware for booting processor-based systems and to basic input/output systems.

A processor-based system may boot using firmware stored on the processor-based system. The boot up processor may be implemented with basic input/output system (BIOS) firmware. Sometimes this firmware needs to be modified. The firmware may be modified to accommodate updates and other variations including new hardware and software components.

In many cases, it is desirable to get new product designs on the market as soon as possible. Especially in the consumer products space, it may be desirable to speed products to market as soon as possible since they may quickly become obsolete.

One barrier to quickly getting new products to market is the need to test various firmware changes. Any firmware change necessarily results in retesting the entire firmware and its operation in the system. Such tests may take several weeks. While the firmware tests are being done, changes to the firmware cannot be made. As a result, the system design is slowed or even, in some cases, halted.

Generally, a new BIOS release may take as long as four weeks to validate. The entire validation process may need to be changed even for very simple variations of the BIOS. In some cases, the BIOS testing involves some 1000 test cases which have to be run again and again until all the defects are fixed. During this long and time consuming period, both the developer and tester wait for the results and then, when they get those results, they may need to do the work all over again.

### BRIEF DESCRIPTION OF THE DRAWINGS

FIG. 1 is a depiction of a test plan developer in accordance with one embodiment of the present invention;

FIG. 2 is a flow chart for the probing utility of FIG. 1 in accordance with one embodiment of the present invention;

FIG. 3 is a flow chart for the test plan generator in accordance with one embodiment shown in FIG. 1;

FIG. 4 shows a system for implementing firmware validation in accordance with one embodiment of the present invention; and

FIG. 5 shows a dedicated test system according to one embodiment of the present invention.

### DETAILED DESCRIPTION

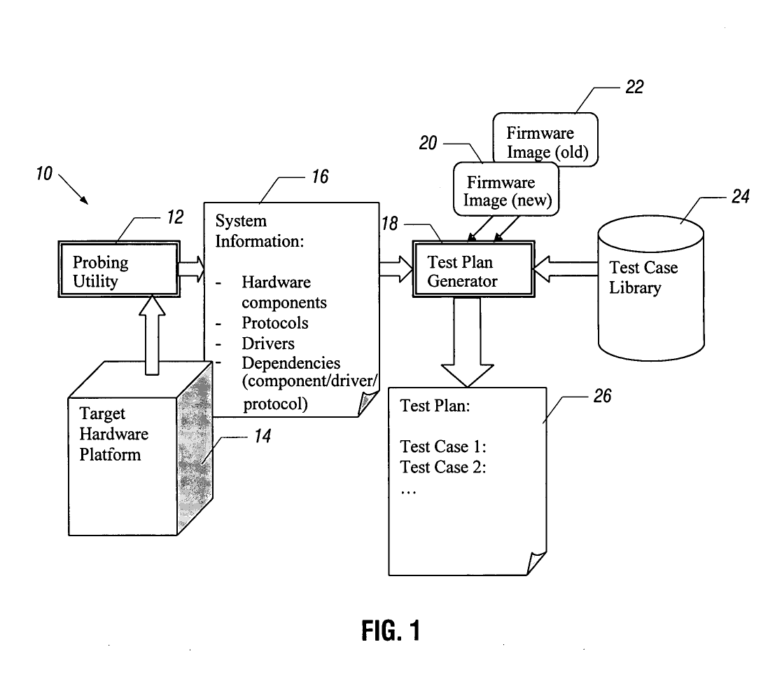

Referring to FIG. 1, a test plan developer 10 may be utilized to develop an efficient plan for testing a new version of firmware such as a basic input/output system. Each change in firmware may be analyzed to determine which tests really need to be run in order to validate the new firmware. Thus, as shown in FIG. 1, the new firmware image 20, which has the change, and the old firmware image 22 are loaded into a test plan generator 18. The test plan generator designs the test plan which, in some cases, quickly tests the new firmware image. This may be important in some cases in speeding the new product design to market as expeditiously as possible.

A probing utility 12 initially probes the platform 14 that will use the new firmware image 20. The probing utility 12 may acquire information about the target hardware platform 14. This may include a complete specification of the system design as it currently exists. The probing utility 12 extracts from the target hardware platform 14 system information, including, in some embodiments, what hardware components are included, what protocols are involved, and what drivers are used, and further determines the dependencies between those components, drivers, and protocols, as indicated in block 16.

In some embodiments, the target hardware platform 14 may be compliant with the Extensible Firmware Interface specification. See EFI 1.10 Specification (2003) available from Intel Corporation, Santa Clara, Calif. In such case, the derivation of the system information 16 may be readily accomplished with utilities already existent in the Extensible Firmware Interface specification compliant platform 14. In cases where the platform 14 is not Extensible Firmware Interface specification compliant, other techniques may be utilized, including the same techniques that are now available within the extensible firmware interface, without actually implementing the Extensible Firmware Interface specification. In addition, system information may be obtained from directories, a registry, or may simply be manually obtained from the design itself.

The system information 16 is then loaded into the test plan generator 18. The test plan generator 18 then consults a library of all the test cases 24. The library 24 provides information about all the possible test cases. The test plan generator 18 analyzes the changes between the old firmware image 22 and the new firmware image 20 and the system information 16 to come up with an efficient test plan 26.

Ideally, the test plan 26 only implements those tests necessitated by the change in the firmware image. As a result, a quicker test and validation may be implemented. For example, generally a new firmware image test may take four weeks, but a fraction of the time may be utilized with an efficiently generated test plan.

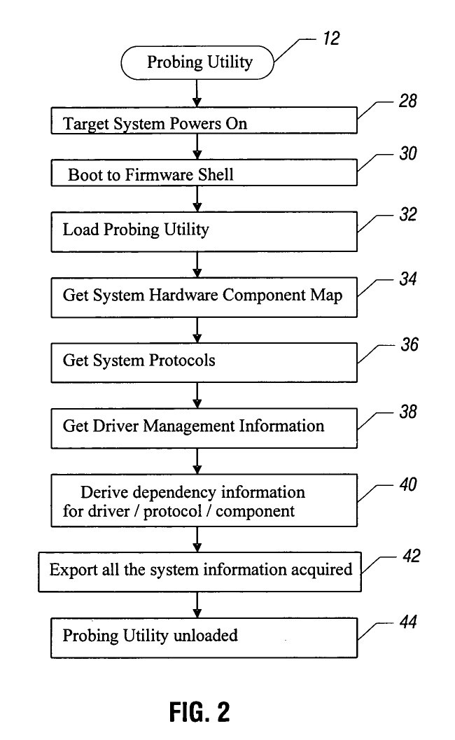

Referring to FIG. 2, the operation of the probing utility 12 is illustrated. The probing utility, in one embodiment, may be a software or firmware component run on a processor-based system. However, other probing utilities may also be utilized.

Initially, the target hardware platform 14 powers on as indicated in block 28. The system is booted to a firmware shell as indicated in block 30. In accordance with a system compliant with the Extensible Firmware Interface specification, that shell may be an extensible firmware interface shell. Then, the probing utility is loaded as indicated in block 32. From the boot up system, the hardware component map may be obtained as indicated in block 34. This may be done using the capabilities of the Extensible Firmware Interface specification compliant platform 14 itself or with similar components or using other techniques such as configuration or registry data.

Next, the system protocols are obtained as indicated in block 36. The protocols may be queried from a database of protocols, one component at a time. All related system protocols can be listed. Then, the driver management information is obtained as indicated in block 38. An EFI implementation records all management relationships between hardware components and software drivers in each protocol. The test infrastructure queries this information from the database for each protocol.

The dependencies between the drivers, protocols, and components are derived as indicated in block 40. The dependency information can be created by using the information obtained in steps 34 through 38.

Next, all the information may be exported, as indicated in block 42, to the test plan generator 18. Thereafter, the probing utility may be unloaded as indicated in block 44.

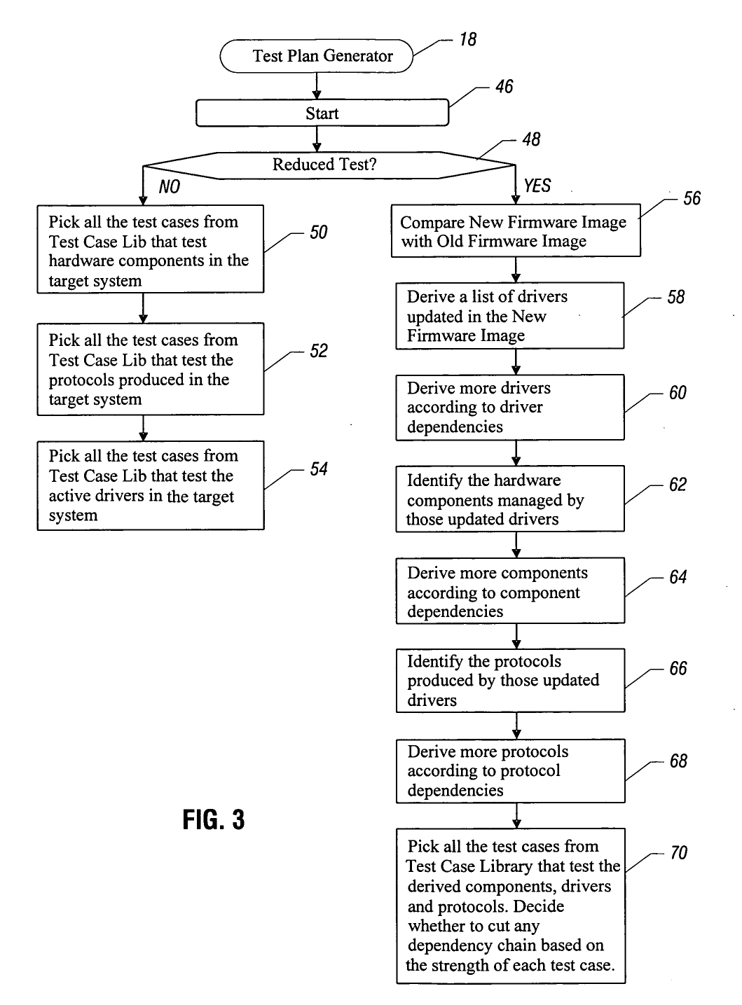

Referring next to FIG. 3, the operation of the test plan generator 18 is illustrated. Again, the test plan generator may be implemented in software, firmware, or hardware in some embodiments. The test plan generator 18 starts at block 46 and, at polygon 48, a determination is made as to whether to undergo a complete firmware test or a reduced test.

If the reduced test is declined, existing techniques may be utilized as indicated in blocks 50, 52, and 54. In such case, all the test cases from the test case library 24 are picked to test the hardware components of the target system as indicated in block 50. All the test cases from the test case library 24 may be used to test the protocols produced in a target system as indicated in block 52. Finally, all the test cases from the test case library 24 are picked that test the active drivers of the target system as indicated in block 54. This may involve on the order of 1000 tests and may be extremely time consuming.

On the other hand, if the reduced test is opted for at polygon 48, the new firmware image 20 is compared to the old firmware image 22 as indicated in block 56. From this comparison, a list of drivers, updated in the new firmware image, are determined as indicated in block 58. More drivers may be identified according to driver dependencies as indicated in block 60.

Then, the hardware components managed by those drivers are identified as indicated in block 62. More components may be derived according to component dependencies as indicated in block 64. Those dependencies may be already known using the Extensible Firmware Interface specification capabilities.

Next, the protocols produced by the updated drivers are identified as indicated in block 66. More protocols may be derived and listed according to protocol dependencies as indicated in block 68.

Finally, the necessary test cases from the test case library 24 are picked to test the derived components, drivers, and protocol. It may be decided whether to cut any dependency chains based on the strength of each test case, all as indicated in block 70.

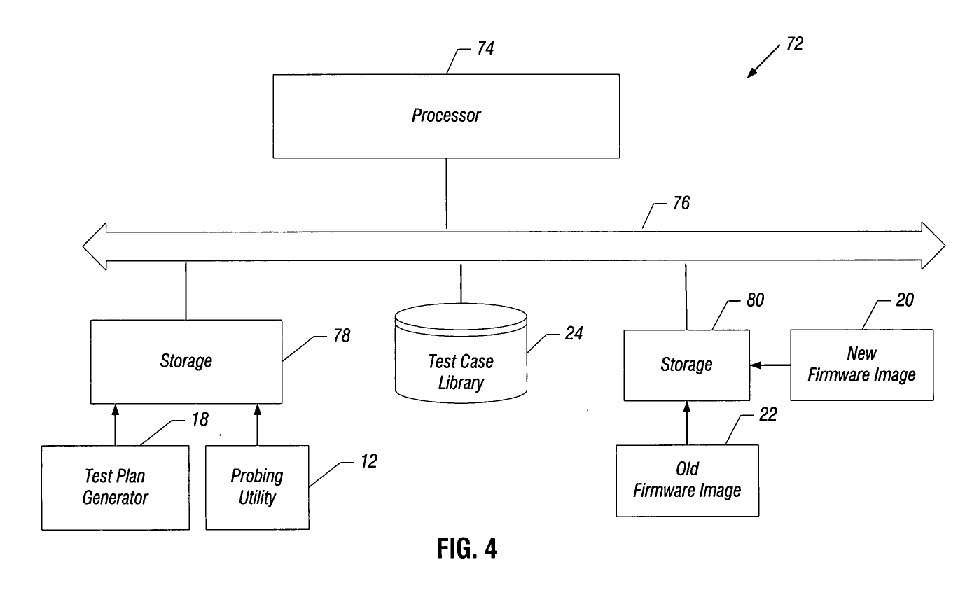

Thus, referring to FIG. 4, the test system 72 may include one or more processors 74. The processors may be coupled to a bus 76. The test case library 24 may be accessible on that bus 76 and may be stored in an appropriate storage device.

Another storage device 78 may store the test plan generator 18 and the probing utility 12. The storage device 78 may be any type of memory, including a semiconductor memory, a magnetic memory, or an optical memory.

The storage device 80 may also store the new firmware image 20 and the old firmware image 22. Like the storage device 78, the storage device 80 may be any kind of memory.

If the tested platform 14 is compliant with the Extensible Firmware Interface specification, it may be readily operated to determine the dependencies between drivers, protocols, and components. In other cases, capabilities similar to those provided in the Extensible Firmware Interface specification, custom developed approaches, or configuration cycle information may be utilized, as well as manual inputting to derive similar information.

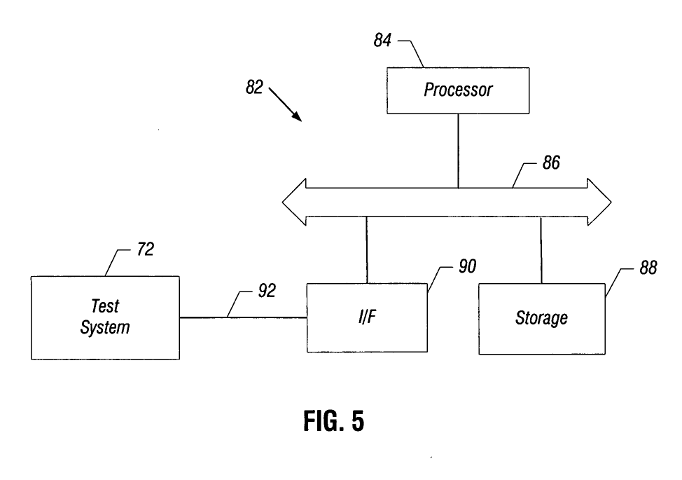

In addition to a test system that is internal to an existing processor-based system, an external test system may also be utilized as indicated in FIG. 5. The external test system 72 may be utilized in connection with standalone personal computers and networked systems as well. In other words, a test system 72 of the type shown in FIG. 4 may operate as a dedicated test system in some embodiments. The test system 72 may then be coupled to standalone personal computers or networked personal computers or other networked processor-based systems. It may be connected through a direct connection, a remote connection, such as over the Internet or a network, or even a wireless connection. In such case, the separate system 72 may be used to accelerate testing of other systems, be they local or remote, and be they single or multiple station systems.

In one embodiment, the test system 72 may be coupled by a link 92 to a system under test 82. The link 92 may be a removable connection such as a pluggable cable or a wireless connection. The connection of the link 92 to the system under test 82 may be through an interface 90. The interface 90 may be a suitable interface for the type of link 92. In one embodiment, it may be a network interface card but, in other embodiments, other interfaces may be utilized.

The interface 90 may be coupled to a bus 86. A storage 88 may also be coupled to the bus 86. The storage 88, for example, may be a dynamic random access memory in one embodiment. The bus 86, in turn, may be coupled to a processor 84. The processor 84 may be any single or multiple sets of processors. Other components may be used as well.

In the embodiments shown in FIG. 5, the test system 72 may be plugged into various standalone and networked systems in order to test firmware in those systems. For example, in one embodiment, the storage 88 may be a firmware storage which may store firmware which is tested by the test system 72.

With embodiments of the present invention, plan test generators can derive the appropriate test to execute through a constructed matrix based on a variety of variable inputs such as functionality changes, including source code and module updates. Changes made in the source code or reflected in the platform can be mapped to test cases that cover the functionality that was impacted by this component or source level change. Through the source/component to test cases mapping mechanism, the source/component level change can be mapped to test cases accurately.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
detecting characteristics of a platform; and
using the detection of those characteristics to determine which tests to run on a new firmware version to validate the new firmware version.

2. The method of claim 1 including reducing the number of tests to be run based on said determination.

3. The method of claim 1 including comparing a new firmware image with an old firmware image.

4. The method of claim 1 including deriving a list of drivers updated in the new firmware image.

5. The method of claim 4 including developing a list of additional drivers according to driver dependencies.

6. The method of claim 4 including deriving a list of hardware components managed by those drivers.

7. The method of claim 6 including deriving additional hardware components according to component dependencies.

8. The method of claim 4 including identifying protocols produced by those updated drivers.

9. The method of claim 8 including identifying additional protocols according to protocol dependencies.

10. The method of claim 9 including selecting test cases from a test case library to test the derived components, drivers, and protocols.

11. A computer readable medium storing instructions that when executed cause a system to:
detect characteristics of a platform; and
use the detection of those characteristics to determine which tests to run on a new firmware version to validate the new firmware version.

12. The medium of claim 11 further storing instructions to reduce the number of tests to be run based on said determination.

13. The medium of claim 11 further storing instructions to compare a new firmware image with an old firmware image.

14. The medium of claim 11 further storing instructions to derive a list of drivers updated in the new firmware image.

15. The medium of claim 14 further storing instructions to developd a list of additional drivers according to driver dependencies.

16. The medium of claim 14 further storing instructions to derive a list of hardware components managed by those drivers.

17. The medium of claim 16 further storing instructions to derive additional hardware components according to component dependencies.

18. The medium of claim 14 further storing instructions to identify protocols produced by those updated drivers.

19. The medium of claim 18 further storing instructions to identify additional protocols according to protocol dependencies.

20. The medium of claim 19 further storing instructions to select test cases from a test case library to test the derived components, drivers, and protocols.

21. A firmware validation system comprising:
a probing utility to determine hardware components, protocols, and drivers of a hardware platform; and
a test plan generator to compare a new firmware image to an old firmware image and to derive a list of drivers updated in the new firmware image.

22. The system of claim 21 including a test case library including a set of possible tests that may be run on said hardware platform, said test plan generator to select some, but not all, of said tests in said test plan library.

23. The system of claim 21, said test plan generator to develop a list of additional drivers according to driver dependencies.

24. The system of claim 21 wherein said test plan generator to develop a list of hardware components managed by said drivers.

25. The system of claim 24, said test plan generator to identify protocols produced by said updated drivers.

26. The system of claim 21 wherein the validation system is internal to a system being tested by said validation system.

27. The system of claim 21 wherein the validation system is removably connectable to a system whose firmware is to be tested by said validation system.
